(19) United States
(12) Patent Application Publication
(10) Pub. No.: US 2026/0336532 A1
(43) Pub. Date: Oct. 29, 2026

(54) CHAINSAW BRACKET

(71) Applicant: HEBEI SNDAS SURVEY AND DRAW CO.,LTD., Xingtai (CN)

(72) Inventor: SHAOCHENG ZHANG, Xingtai (CN)

(21) Appl. No.: 19/694,793

(22) Filed: Jun. 1, 2026

(51) Int. Cl. B60R 11/06; B27B 17/00; B60R 11/00

(52) U.S. Cl. CPC B60R 11/06; B27B 17/00; B60R 2011/0075

(57) ABSTRACT

A chainsaw bracket, including: a mounting assembly, a door, and a protective sheath. The mounting assembly is configured to be connected to a vehicle. The door has a first end rotatably connected to a first end of the mounting assembly and a second end detachably connected to a second end of the mounting assembly. The protective sheath defines a receiving space for accommodating a cutting portion of a chainsaw and an opening in communication with the receiving space. When the second end of the door is connected to the second end of the mounting assembly, the door and the mounting assembly define a installation space therebetween configured to receive the protective sheath.

### TECHNICAL FIELD

The present disclosure relates to the technical field of vehicle-mounted storage devices, in particular to a chainsaw bracket

### BACKGROUND

When using multi-purpose vehicles, all-terrain vehicles, tractors and other vehicles, people sometimes need to carry tools such as chainsaws, but carrying chainsaws creates many problems.

On the one hand, placing the chainsaw directly in the cab or storage box occupies a large space, and sometimes the chainsaw is too large in volume or the remaining volume of the storage box is insufficient, making it impossible to fully accommodate the chainsaw. On the other hand, when the chainsaw is placed directly in the cab or storage box, the chainsaw is prone to collision or even falling during transportation. Some existing products directly provide a bracket on the vehicle and insert the chainsaw directly into it. However, such products are very inconvenient when withdrawing the chainsaw, especially when the saw blade is relatively long.

### SUMMARY

In order to overcome the deficiencies of the prior art, the present disclosure provides a chainsaw bracket, which can effectively accommodate and protect the chainsaw without occupying space in the cab or storage box, and is convenient for users to access.

The technical solution adopted by the present disclosure to solve its technical problems is as follows:
a chainsaw bracket, including: a mounting assembly configured to be connected to a vehicle; a door having a first end rotatably connected to a first end of the mounting assembly and a second end detachably connected to a second end of the mounting assembly; and a protective sheath defining a receiving space for accommodating a cutting portion of a chainsaw and an opening in communication with the receiving space;
wherein, when the second end of the door is connected to the second end of the mounting assembly, the door and the mounting assembly define an installation space therebetween configured to receive the protective sheath.

In one embodiment, the mounting assembly comprises a mounting base including a plate-shaped main body, a first connecting plate extending from one side of an outer surface of the plate-shaped main body, and a second connecting plate extending from an opposite side of the outer surface of the plate-shaped main body; wherein the first end of the door is rotatably connected to the first connecting plate, the second end of the door is detachably connected to the second connecting plate; and the installation space is defined by the door, the plate-shaped main body, the first connecting plate, and the second connecting plate.

In one embodiment, a first gasket is disposed on the outer surface of the plate-shaped main body, and a second gasket is provided on an inner surface of the door.

In one embodiment, the protective sheath comprises a flange extending outwardly from the opening, and the flange is configured to rest on or abut against upper edges of the plate-shaped main body, the first connecting plate and the second connecting plate.

In one embodiment, a first limiting block protrudes upwardly from an upper surface of the first connecting plate at a position distal from the plate-shaped main body, and a second limiting block protrudes upwardly from an upper surface of the second connecting plate at a position distal from the plate-shaped main body, wherein the first limiting block and the second limiting block are configured to abut against an outer surface of the flange.

In one embodiment, a third gasket is disposed on an upper surface of the flange.

In one embodiment, the mounting base further comprises a rotating shaft, and the rotating shaft is connected to the door and the first connecting plate to allow the door to rotate relative to the first connecting plate.

In one embodiment, the first connecting plate comprises two shaft connecting portions extending away from the second connecting plate at an upper end and a lower end thereof, respectively, and upper and lower ends of the rotating shaft are pivotably connected to the two shaft connecting portions.

In one embodiment, the chainsaw bracket further comprises a hand-tightened screw, wherein a connecting block protrudes from a surface of the second connecting plate facing away from the first connecting plate, and a threaded end of the hand-tightened screw passes through the door and is threadedly and detachably engaged with the connecting block.

In one embodiment, a side of the first connecting plate distal from the plate-shaped main body defines a first notch, a side of the second connecting plate distal from the plate-shaped main body defines a second notch; the door is at least partially received within the first notch and the second notch, when the second end of the door is connected to the mounting assembly.

In one embodiment, a spacing exists between a lower inner wall of the first notch and an upper surface of the shaft connecting portion at the lower end of the first connecting plate; the door is sleeved on the rotating shaft and is configured to slide axially along the rotating shaft, and when the door is rotated to an open position, the door slides downward along the rotating shaft and abuts against the first connecting plate to prevent further rotation of the door.

In one embodiment, the protective sheath comprises a first sheath shell having a first receiving space penetrating up and down and a second sheath shell having a second receiving space detachably connected to a lower portion of the first sheath shell; wherein the receiving space is defined by the first sheath shell and the second sheath shell.

In one embodiment, a bottom of the second sheath shell is provided with a drainage hole communicated with the second receiving space.

In one embodiment, the first sheath shell is provided with an insertion portion, the second sheath shell is provided with an insertion groove; wherein when the second sheath shell is connected to the lower portion of the first sheath shell, the insertion portion is inserted into the insertion groove.

In one embodiment, a protective component is provided inside the protective sheath, the protective component being strip-shaped and extending along left and right inner sidewalls of the receiving space.

In one embodiment, the mounting assembly further comprises a first clamping plate, a second clamping plate, two bolts and two first nuts; the first clamping plate is provided with a first through hole and a second through hole, the second clamping plate is provided with a third through hole and a fourth through hole; the two bolts are configured as follows: one bolt passes through the first through hole and the third through hole, another bolt passes through the second through hole and the fourth through hole; the two first nuts are respectively connected to the two bolts, and the two first nuts and bolt heads of the two bolts respectively abut against an inner surface of the first clamping plate and an outer surface of the second clamping plate, thereby causing the first clamping plate and the second clamping plate to stably clamped on the vehicle.

In one embodiment, a fifth through hole and a sixth through hole are respectively provided at two ends of the plate-shaped main body; the mounting assembly further comprises two second nuts, wherein one of the two bolts passes through the fifth through hole and another one of the two bolts passes through the sixth through hole, and the two second nuts are respectively threadedly engaged with the two bolts and abut against the outer surface of the plate-shaped main body, thereby connecting the plate-shaped main body to the second clamping plate.

In one embodiment, the mounting base further comprises two door-shaped protruding portions connected to an inner side surface of the plate-shaped main body, and the door-shaped protruding portions abut against the outer surface of the second clamping plate.

In one embodiment, ends of the two door-shaped protruding portions away from the plate-shaped main body are each provided with an avoidance hole, and the first nut is located within the avoidance hole.

The beneficial effects of the present disclosure are: through the arrangement of the above structure, the mounting assembly is connected to a vertical frame of a vehicle, especially a multi-purpose vehicle, all-terrain vehicle, tractor or other vehicle. When transporting the chainsaw, the cutting portion (saw blade portion) of the chainsaw is inserted into the accommodating space along the opening, the protective sheath is placed at the mounting assembly, the door is rotated to the closed position, the second end of the door is connected to the second end of the mounting assembly, and the door and the mounting assembly respectively clamp opposite sides of the protective sheath, thereby effectively fixing the protective sheath and, in turn, fixing the chainsaw, which is convenient for carrying the chainsaw without occupying space in the cab or storage box. At the same time, the protective sheath can also provide protection for the cutting portion of the chainsaw. When accessing the chainsaw, the door can be rotated to the open position, the chainsaw and the protective sheath can be removed, and then the chainsaw can be taken out from the protective sheath, which is convenient for users to use. Furthermore, the cutting portion of the chainsaw is located in the accommodating space, and the protective sheath can protect the cutting portion of the chainsaw to avoid damage caused by collision or falling of the chainsaw during transportation.

### BRIEF DESCRIPTION OF DRAWINGS

In order to more clearly illustrate the technical solutions in the embodiments of the present disclosure, the drawings required for use in the description of the embodiments will be briefly introduced below. The drawings in the following description are merely some embodiments of the present disclosure. For those of ordinary skill in the art, other drawings can also be obtained based on these drawings without creative effort.

The present disclosure will be further described below in conjunction with the drawings and embodiments.

FIG. 1 is a schematic structural diagram of a chainsaw bracket of the present disclosure from one angle when a door is in a closed position.

FIG. 2 is a schematic structural diagram of the chainsaw bracket of the present disclosure from another angle when the door is in the closed position.

FIG. 3 is a schematic structural diagram of the chainsaw bracket of the present disclosure when the door is in the open position.

FIG. 4 is a schematic structural diagram of the chainsaw bracket of the present disclosure when the door is in the open position and the protective sheath is removed.

FIG. 5 is a schematic cross-sectional structural view of the chainsaw bracket of the present disclosure.

FIG. 6 is an enlarged view of the portion A circled in FIG. 4.

FIG. 7 is an enlarged view of the portion B circled in FIG. 5.

FIG. 8 is a schematic exploded structural view of the chainsaw bracket of the present disclosure from one angle.

FIG. 9 is a schematic exploded structural view of the chainsaw bracket of the present disclosure from another angle.

### DETAILED DESCRIPTION OF THE EMBODIMENTS

In order to make the above objectives, features and advantages of the present disclosure more obvious and understandable, the specific embodiments of the present disclosure will be described in detail below with reference to the accompanying drawings. In the following description, numerous specific details are set forth in order to provide a full understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

In the description of the present disclosure, it should be understood that if the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. appear, these terms indicate the orientation or positional relationship based on the orientation or positional relationship shown in the drawings, and are only for the convenience of describing the present disclosure and simplifying the description, rather than indicating or implying that the referred device or element must have a specific orientation, be constructed and operated in a specific orientation, and therefore cannot be understood as a limitation on the present disclosure.

In addition, if the terms “first” and “second” appear, these terms are used for descriptive purposes only and cannot be understood as indicating or implying relative importance or implicitly indicating the number of the indicated technical features. Thus, a feature defined as “first” or “second” may explicitly or implicitly include at least one of that feature. In the description of the present disclosure, if the term “plurality” appears, the meaning of “plurality” is at least two, such as two, three, etc., unless otherwise clearly and specifically limited.

In the present disclosure, unless otherwise clearly specified and limited, if the terms “mount”, “connect”, “link”, “fix”, etc. appear, these terms should be understood in a broad sense. For example, it can be a fixed connection, a detachable connection, or an integral connection; it can be a mechanical connection or an electrical connection; it can be a direct connection or an indirect connection through an intermediate medium, or it can be the internal communication of two elements or the interaction relationship between two elements, unless otherwise clearly limited. For those of ordinary skill in the art, the specific meanings of the above terms in the present disclosure can be understood according to specific circumstances.

In the present disclosure, unless otherwise clearly specified and limited, if similar descriptions such as a first feature being “on” or “under” a second feature appear, the meaning may be that the first and second features are in direct contact, or the first and second features are in indirect contact through an intermediate medium. Moreover, the first feature being “above”, “over” and “on” the second feature may mean that the first feature is directly above or obliquely above the second feature, or simply that the first feature is horizontally higher than the second feature. The first feature being “below”, “under” and “beneath” the second feature may mean that the first feature is directly below or obliquely below the second feature, or simply that the first feature is horizontally lower than the second feature.

It should be noted that if an element is referred to as being “fixed to” or “disposed on” another element, it may be directly on the other element or there may be an intervening element. If an element is considered to be “connected to” another element, it may be directly connected to the other element or there may be an intervening element at the same time. If present, the terms “vertical”, “horizontal”, “upper”, “lower”, “left”, “right” and similar expressions used in this application are for illustrative purposes only and do not mean they are the only embodiments.

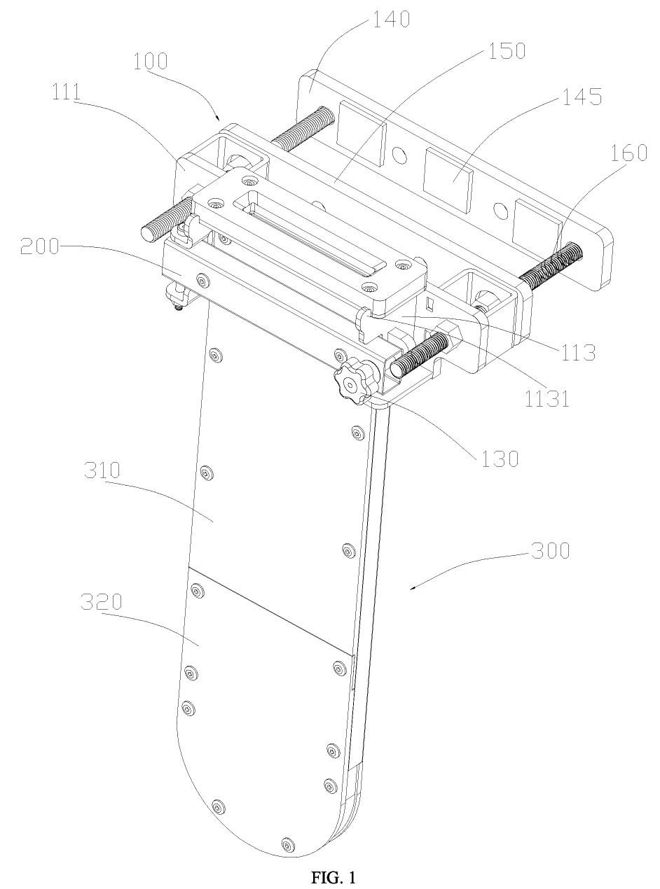

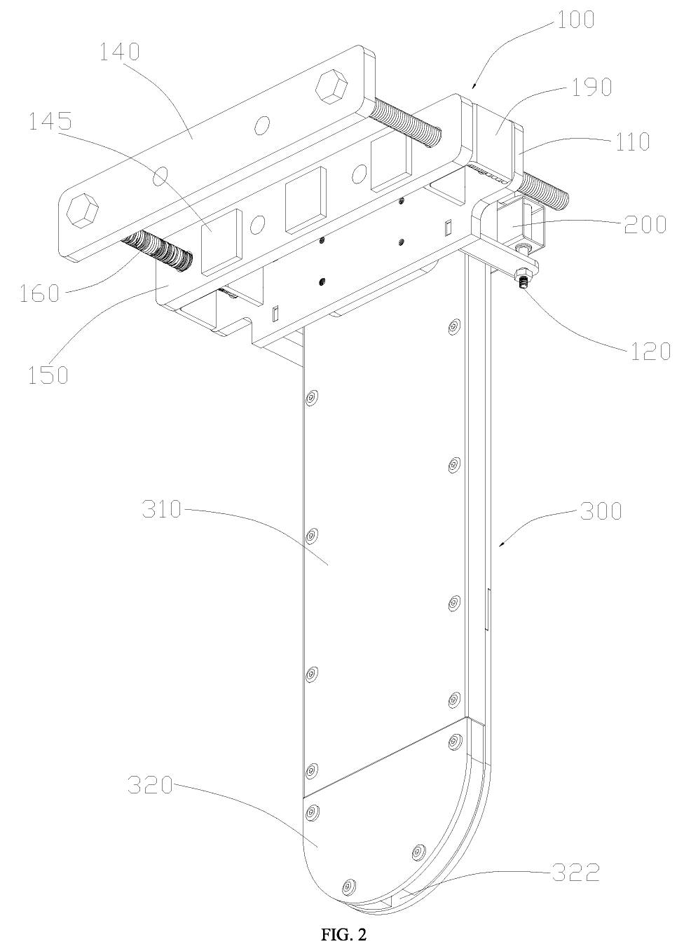

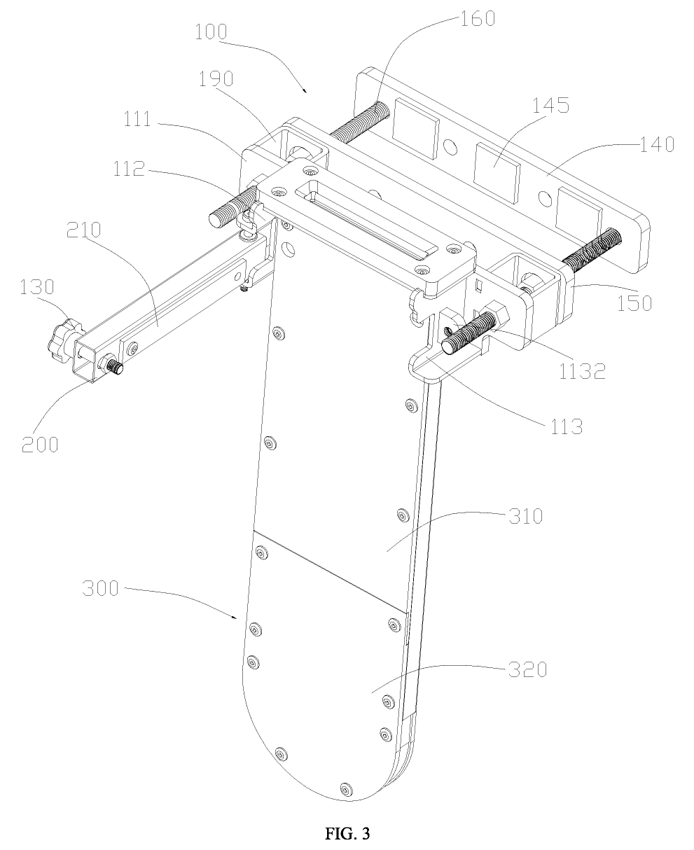

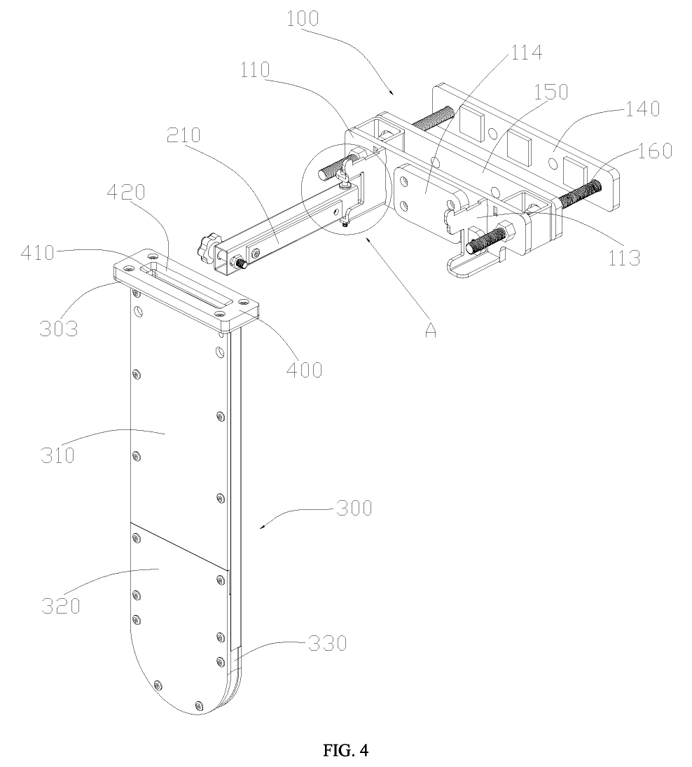

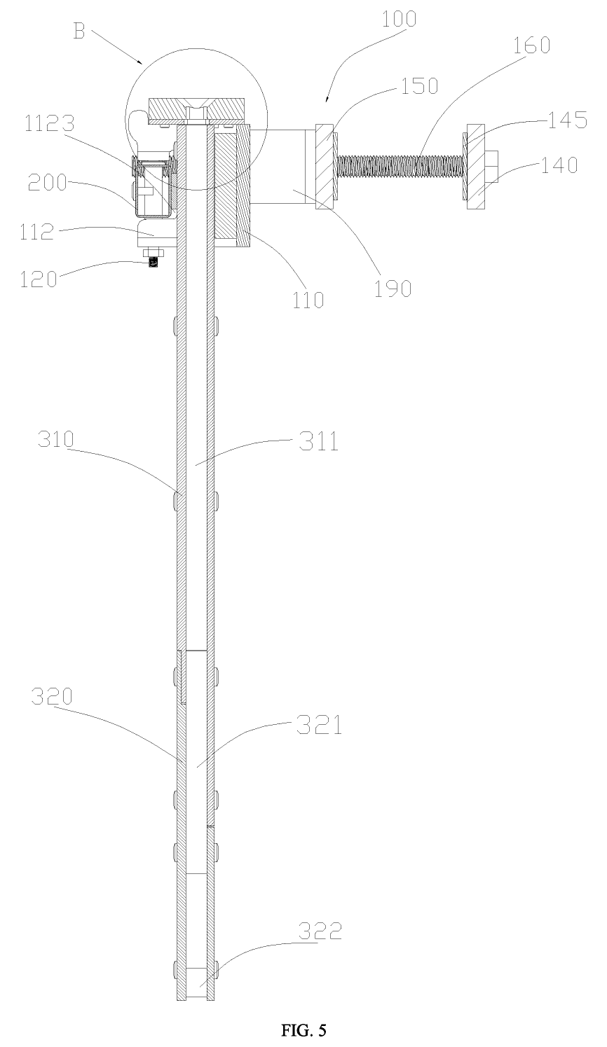

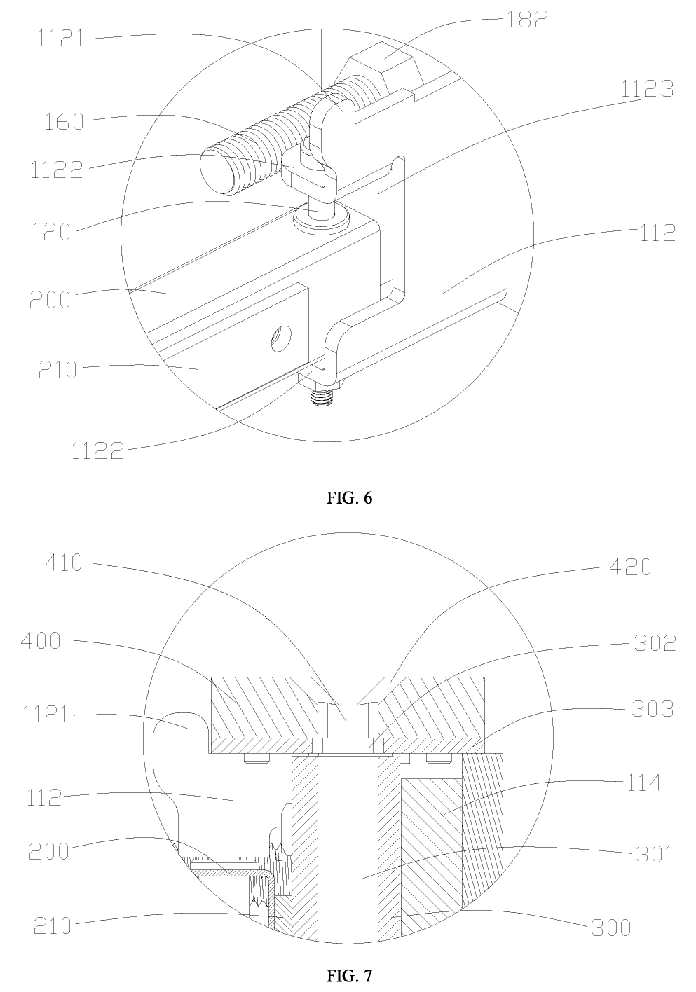

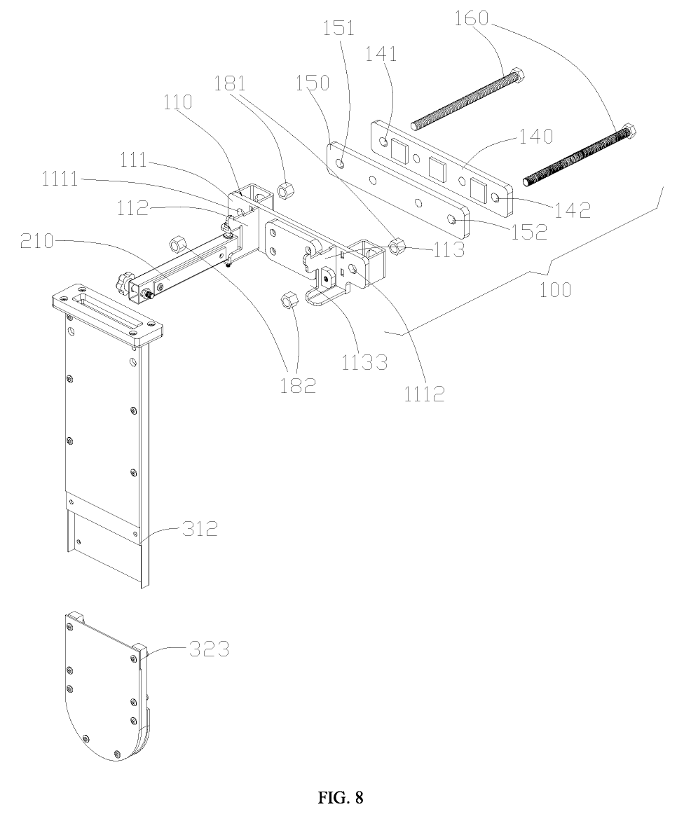

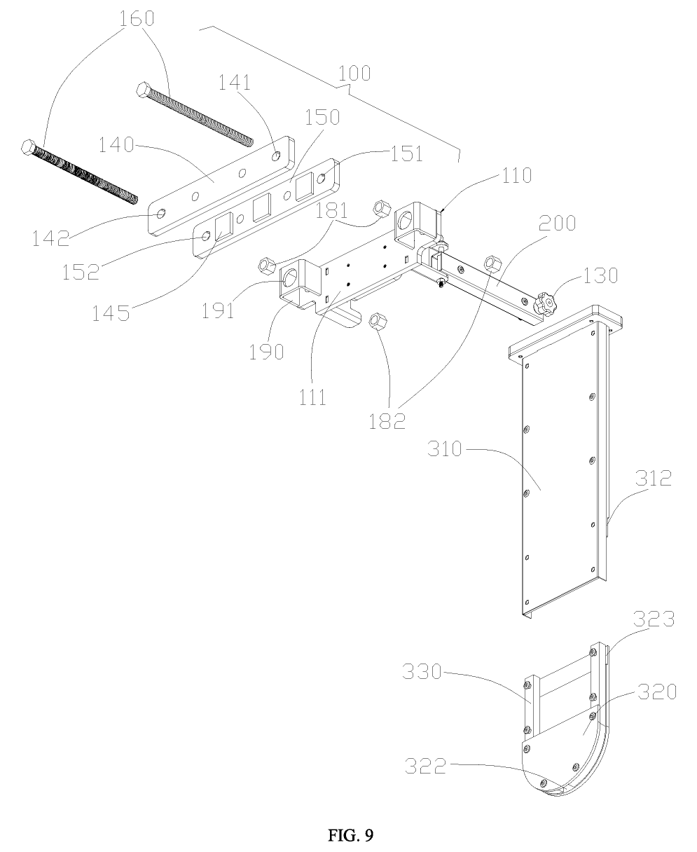

Referring to FIGS. 1-9, a chainsaw bracket, including:
a mounting assembly 100 configured to be connected to a vehicle;
a door 200 having a first end rotatably connected to a first end of the mounting assembly 100 and a second end detachably connected to a second end of the mounting assembly 100;
a protective sheath 300 defining a receiving space 301 for accommodating a cutting portion of a chainsaw and an opening 302 in communication with the receiving space 301;
when the second end of the door 200 is connected to the second end of the mounting assembly 100, the door 200 and the mounting assembly 100 define an installation space therebetween configured to receive the protective sheath 300.

With the above structure, the mounting assembly 100 is connected to a vehicle, in particular to a vertical frame of a utility vehicle, an all-terrain vehicle, a tractor or the like. To transport a chainsaw 800, the cutting portion 810 (saw blade) of the chainsaw 800 is inserted into the receiving space 301 through the opening 302. The protective sheath 300 is placed at the mounting assembly 100, and the door 200 is rotated to the closed position and secured at its second end to the mounting assembly 100. In this way, the door 200 and the mounting assembly 100 define the installation space to receive the protective sheath 300, securely fixing the protective sheath 300 and thus the chainsaw 800. This arrangement allows convenient transport of the chainsaw 800 without occupying the cab or storage box space. Meanwhile, the protective sheath 300 protects the cutting portion 810 from damage due to collisions or drops during transportation. When removing the chainsaw 800, the user simply opens the door 200, removes the protective sheath 300 together with the chainsaw, and withdraws the chainsaw from the sheath. Moreover, since the cutting portion 810 of the chainsaw 800 is located within the receiving space 301, the protective sheath 300 can protect the cutting portion 810 of the chainsaw 800 and prevent damage to the chainsaw 800 caused by collision or falling during transportation. Preferably, the door 200 and the mounting assembly 100 are respectively clamped on both sides of the protective sheath 300, which can prevent the protective sheath 300 from wobbling within the insertion space, thereby avoiding collisions and damage to the chainsaw 800 caused by such wobbling.

In this embodiment, the mounting assembly 100 includes a mounting base 110. The mounting base 110 includes a plate-shaped main body 111, a first connecting plate 112 and a second connecting plate 113. The first connecting plate 112 is connected to one side of the outer surface of the plate-shaped main body 111, and the second connecting plate 113 is connected to the other side of the outer surface of the plate-shaped main body 111. The first end of the door 200 is rotatably connected to the first connecting plate 112, and the second end of the door 200 is detachably connected to the second connecting plate 113. The door 200, the plate-shaped main body 111, the first connecting plate 112 and the second connecting plate 113 together enclose and form the installation space. The protective sheath 300 is placed between the first connecting plate 112 and the second connecting plate 113, then the door 200 is rotated to the closed position, and the second end of the door 200 is connected to the second connecting plate 113. At this time, the door 200, the plate-shaped main body 111, the first connecting plate 112 and the second connecting plate 113 together enclose and form the installation space, and the door 200 and the plate-shaped main body 111 respectively clamp the inner and outer sides of the protective sheath 300, thereby effectively fixing the protective sheath 300 and facilitating the carrying of the chainsaw 800. The first connecting plate 112 and the second connecting plate 113 protrude from the outer surface of the plate-shaped main body 111, which can increase the distance between the door 200 and the plate-shaped main body 111, so that the installation space can accommodate the protective sheath 300.

In this embodiment, a first gasket 114 is provided on the outer surface of the plate-shaped main body 111, and a second gasket 210 is provided on an inner surface of the door 200. When the door 200 is rotated to the closed position, the first gasket 114 is pressed against the inner surface of the protective sheath 300, and the second gasket 210 is pressed against the outer surface of the protective sheath 300. The protective sheath 300 is fixed by the friction force between the protective sheath 300 and the first gasket 114 as well as the second gasket 210, so that the protective sheath 300 is stably fixed within the installation space. Preferably, the first gasket 114 and the second gasket 210 are made of a high-friction material such as foam, rubber, or plastic.

In this embodiment, the protective sheath 300 extends outwardly at the opening 302 to form a flange 303. The flange 303 is configured to rest on or abut against upper edges of the plate-shaped main body 111, the first connecting plate 112 and the second connecting plate 113. When transporting the chainsaw, the protective sheath 300 is placed between the first connecting plate 112 and the second connecting plate 113, and the flange 303 abuts against upper edges of the plate-shaped main body 111, the first connecting plate 112 and the second connecting plate 113, thereby supporting the protective sheath 300. Then the door 200 is rotated to the closed position, and the second end of the door 200 is connected to the second connecting plate 113, so that the door 200 and the plate-shaped main body 111 respectively clamp two sides of the protective sheath 300. The flange 303 abutting against the upper edge of the plate-shaped main body 111, the upper edge of the first connecting plate 112 and the upper edge of the second connecting plate 113 can provide support for the protective sheath 300 when the user opens or closes the door 200, preventing the protective sheath 300 from falling when the door 200 is opened, and eliminating the need for the user to support the protective sheath 300 with hands when closing the door 200, thereby facilitating user operation.

In this embodiment, a first limiting block 1121 protrudes upwardly from an upper surface of the first connecting plate 112 at a position distal from the plate-shaped main body 111, and a second limiting block 1131protrudes upwardly from an upper surface of the second connecting plate 113 at a position distal from the plate-shaped main body 111. The first limiting block 1121 and the second limiting block 1131 are configured to abut against the outer surface of the flange 303. When the door 200 is in the open position, the flange 303 abuts against the upper edge of the plate-shaped main body 111, the upper edge of the first connecting plate 112 and the upper edge of the second connecting plate 113, and the first limiting block 1121 and the second limiting block 1131 can prevent the flange 303 from moving outward. The user does not need to hold the protective sheath 300 by hand, and the protective sheath 300 can be limited between the first connecting plate 112 and the second connecting plate 113, which is convenient for user operation.

In this embodiment, a third gasket 400 is disposed on an upper surface of the flange 303. The third gasket 400 can protect the flange 303, especially when the saw blade portion of the chainsaw is inserted into the opening 302, the saw blade portion of the chainsaw is prone to scrape the surface of the flange 303. The provision of the third gasket 400 can protect the flange 303. Preferably, the third gasket 400 is provided with a through hole 410 corresponding to the opening 302, and a guiding inclined surface 420 is provided at the through hole 410. The guiding inclined surface 420 enables the user to more easily pass the saw blade portion of the chainsaw through the through hole 410 and the opening 302 and insert it into the receiving space 301. Preferably, the third gasket 400 is made of foam, rubber or plastic material.

In this embodiment, the mounting base 110 further includes a rotating shaft 120, and the rotating shaft 120 is connected to the door 200 and the first connecting plate 112 to allow the door 200 to rotate relative to the first connecting plate 112.

In this embodiment, the first connecting plate 112 is provided with two shaft connecting portions 1122. The two shaft connecting portions 1122 are respectively located at the upper end and the lower end of the first connecting plate 112 and extend in a direction away from the second connecting plate 113. The upper and lower ends of the rotating shaft 120 are respectively connected to the two shaft connecting portions 1122. The two shaft connecting portions 1122 protrude from the surface of the first connecting plate 112 and are arranged substantially horizontally. The rotating shaft 120 passes through the two shaft connecting portions 1122 and the door 200 located between the two shaft connecting portions 1122, which is convenient for assembly and has a stable structure.

In this embodiment, the chainsaw bracket further includes a hand-tightened screw 130. A connecting block 1132 protrudes from a surface of the second connecting plate 113 facing away from the first connecting plate 112, and a threaded end of the hand-tightened screw 130 passes through the door 200 and is threadedly and detachably engaged with the connecting block 1132. When the door 200 is rotated to the closed position, the user can rotate the hand-tightened screw 130 so that the threaded end of the hand-tightened screw 130 is connected to or detached from the connecting block 1132, thereby realizing locking and releasing of the door 200. The operation is convenient, the structure is stable, and it is ensured that the door 200 will not be accidentally opened during vehicle driving.

In this embodiment, a first notch 1123 is provided on the side of the first connecting plate 112 away from the plate-shaped main body 111, and a second notch 1133 is provided on the side of the second connecting plate 113 away from the plate-shaped main body 111. When the second end of the door 200 is connected to the second end of the mounting assembly 100, the door 200 is at least partially located within the first notch 1123 and the second notch 1133. When the door 200 is rotated to the closed position, the door 200 is substantially embedded in the first notch 1123 and the second notch 1133, that is, the outer surface of the first connecting plate 112 and the outer surface of the second connecting plate 113 are substantially flush with the outer surface of the door 200, thereby preventing the door 200 from being accidentally opened due to scraping against obstacles during vehicle driving and transportation.

In this embodiment, a spacing d exists between an inner wall of a lower side of the first notch 1123 and an upper surface of the shaft connecting portion 1122 at the lower end of the first connecting plate 112. The door 200 is sleeved on the rotating shaft 120 and can slide axially along the rotating shaft 120. When the door 200 is rotated to the open position, the door 200 slides downward axially along the rotating shaft 120, and the door 200 abuts against the first connecting plate 112 to hinder the rotation of the door 200. When the door 200 is in a non-open position, the door 200 rotates around the rotating shaft 120, and the lower surface of the door 200 abuts against the inner wall of the lower side of the first notch 1123. When the door 200 is rotated to the open position, the lower surface of the door 200 disengages from the inner wall of the lower side of the first notch 1123, and the door 200 slides downward along the rotating shaft 120 under the action of gravity. Thereafter, the door 200 abuts against the surface of the first connecting plate 112 to hinder the rotation of the door 200, thereby fixing the door in the open position. Conversely, when rotating the door 200 to the closed position, the door 200 needs to be lifted upward first so that the door 200 corresponds to the first notch 1123, and then the door 200 is rotated toward the closed position.

In this embodiment, the protective sheath 300 includes a first sheath housing 310 and a second sheath housing 320. The first sheath housing 310 is provided with a first accommodating space 311 that penetrates vertically therethrough. The second sheath housing 320 is provided with a second accommodating space 321. The second sheath housing 320 is detachably connected to a lower portion of the first sheath housing 310, and the first sheath housing 310 and the second sheath housing 320 together enclose and form the accommodating space 301.

The first sheath housing 310 and the second sheath housing 320 are provided in a split-type configuration. When transporting the product, the two sheath housings can be stacked on top of each other, thereby reducing the overall length of the product and facilitating transportation. When the product is in use, the second sheath housing 320 can be connected to the lower portion of the first sheath housing 310 to form an integrated protective sheath 300, which can effectively protect the saw blade portion of the chainsaw. When the saw blade portion of the chainsaw is relatively long, the second sheath housing 320 can also be removed, and only the saw blade portion of the chainsaw can be inserted into the first accommodating space 311, which can still carry the chainsaw. Alternatively, a second sheath housing 320 of greater length can be connected to the lower portion of the first sheath housing 310 so as to be suitable for chainsaws having saw blade portions of different lengths.

In this embodiment, a drainage hole 322 is provided at the bottom of the second sheath housing 320, and the drainage hole 322 communicates with the second accommodating space 321. The drainage hole 322 is arranged at the bottom of the second sheath housing 320. When rainwater or other accumulated water enters the second accommodating space 321, it can be discharged along the drainage hole 322, thereby preventing the chainsaw from being dampened and rusting.

In this embodiment, the first sheath housing 310 is provided with an insertion portion 312, and the second sheath housing 320 is provided with an insertion groove 323. When the second sheath housing 320 is connected to the lower portion of the first sheath housing 310, the insertion portion 312 is inserted into the insertion groove 323. When assembling the first sheath housing 310 and the second sheath housing 320, the insertion portion 312 is inserted along the insertion groove 323, and then the two are connected by connecting members such as screws. The connection is stable, and after the insertion portion 312 is inserted into the insertion groove 323, the screw holes of the first sheath housing 310 and the second sheath housing 320 are aligned with each other, which facilitates user operation.

In this embodiment, a protective component 330 is provided inside the protective sheath 300. The protective component 330 is in the shape of a strip, and the protective component 330 extends along the left and right side walls of the accommodating space 301. The protective component 330 extends along the left and right side walls of the accommodating space 301 and faces the saw blade portion of the chainsaw, thereby providing cushioning and protecting the saw blade portion. Preferably, the protective component 330 is made of foam, rubber, or plastic material.

In this embodiment, the mounting assembly 100 further includes a first clamping plate 140, a second clamping plate 150, two bolts 160, and two first nuts 181. The first clamping plate 140 is provided with a first through hole 141 and a second through hole 142. The second clamping plate 150 is provided with a third through hole 151 and a fourth through hole 152. One bolt 160 passes through the first through hole 141 and the third through hole 151, and the other bolt 160 passes through the second through hole 142 and the fourth through hole 152. The two first nuts 181 are respectively connected to the two bolts 160. The first nuts 181 and the bolt heads of the bolts 160 respectively abut against the inner surface of the first clamping plate 140 and the outer surface of the second clamping plate 150, so that the first clamping plate 140 and the second clamping plate 150 can be stably clamped onto a vehicle.

During assembly, the first clamping plate 140 and the second clamping plate 150 are respectively placed on the front and rear sides of a vertical frame of the vehicle. Then, one bolt 160 passes through the first through hole 141 and the third through hole 151, the other bolt 160 passes through the second through hole 142 and the fourth through hole 152, and the two first nuts 181 are tightened, thereby clamping the first clamping plate 140 and the second clamping plate 150 onto the vertical frame of the vehicle. The connection is stable and the operation is simple, and there is no need to drill holes in the vertical frame of the vehicle. Preferably, a fourth gasket 145 is further provided on the surfaces of the first clamping plate 140 and the second clamping plate 150. When the first clamping plate 140 and the second clamping plate 150 are connected to the vertical frame of the vehicle, the fourth gaskets 145 closely fit against the vertical frame of the vehicle, thereby avoiding damage to the vertical frame of the vehicle or the paint surface thereon. The fourth gasket 145 is made of foam, rubber, or plastic material.

In this embodiment, a fifth through hole 1111 and a sixth through hole 1112 are respectively provided at two ends of the plate-shaped main body 111. The mounting assembly 100 further includes two second nuts 182. One bolt 160 passes through the fifth through hole 1111, and another bolt 160 passes through the sixth through hole 1112. The two second nuts 182 are respectively connected to the two bolts 160. The second nuts 182 abut against the outer surface of the plate-shaped main body 111, so that the plate-shaped main body 111 is connected to the second clamping plate 150. When installing the product, one bolt 160 is passed through the fifth through hole 1111, another bolt 160 is passed through the sixth through hole 1112, and then the second nuts 182 are tightened, thereby fixedly connecting the plate-shaped main body 111 to the second clamping plate 150. The connection is convenient.

In this embodiment, the mounting base 110 further includes two door-shaped protruding portions 190. The two door-shaped protruding portions 190 are connected to the inner side surface of the plate-shaped main body 111, and the door-shaped protruding portions 190 abut against the outer surface of the second clamping plate 150. When installing the product, the door-shaped protruding portions 190 abut against the outer surface of the second clamping plate 150, so that a gripping space exists between the plate-shaped main body 111 and the second clamping plate 150, which facilitates the user in grasping the second clamping plate 150. This prevents the distance between the plate-shaped main body 111 and the second clamping plate 150 from being too small during product connection, which could otherwise pinch the user's hand. Moreover, the provision of the door-shaped protruding portions 190 can also increase the distance between the chainsaw main body and the vertical frame of the vehicle, thereby avoiding collision of the chainsaw main body with the vertical frame of the vehicle during vehicle travel.

In this embodiment, an avoidance hole 191 is provided at the end of each of the two door-shaped protruding portions 190 facing away from the plate-shaped main body 111, and the first nut 181 is located within the avoidance hole 191. The first nut 181 is located within the avoidance hole 191, so that the door-shaped protruding portion 190 can avoid the first nut 181 and directly abut against the second clamping plate 150, resulting in more stable abutment.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A chainsaw bracket, comprising:
a mounting assembly configured to be connected to a vehicle;
a door having a first end rotatably connected to a first end of the mounting assembly and a second end detachably connected to a second end of the mounting assembly; and
a protective sheath defining a receiving space for accommodating a cutting portion of a chainsaw and an opening in communication with the receiving space;
wherein, when the second end of the door is connected to the second end of the mounting assembly, the door and the mounting assembly define an installation space therebetween configured to receive the protective sheath.

2. The chainsaw bracket according to claim 1, wherein the mounting assembly comprises a mounting base including a plate-shaped main body, a first connecting plate extending from one side of an outer surface of the plate-shaped main body, and a second connecting plate extending from an opposite side of the outer surface of the plate-shaped main body;
wherein the first end of the door is rotatably connected to the first connecting plate, the second end of the door is detachably connected to the second connecting plate; and
the installation space is defined by the door, the plate-shaped main body, the first connecting plate, and the second connecting plate.

3. The chainsaw bracket according to claim 2, wherein a first gasket is disposed on the outer surface of the plate-shaped main body, and a second gasket is provided on an inner surface of the door.

4. The chainsaw bracket according to claim 2, wherein the protective sheath comprises a flange extending outwardly from the opening, and the flange is configured to rest on or abut against upper edges of the plate-shaped main body, the first connecting plate and the second connecting plate.

5. The chainsaw bracket according to claim 4, wherein a first limiting block protrudes upwardly from an upper surface of the first connecting plate at a position distal from the plate-shaped main body, and a second limiting block protrudes upwardly from an upper surface of the second connecting plate at a position distal from the plate-shaped main body, wherein the first limiting block and the second limiting block are configured to abut against an outer surface of the flange.

6. The chainsaw bracket according to claim 4, wherein a third gasket is disposed on an upper surface of the flange.

7. The chainsaw bracket according to claim 2, wherein the mounting base further comprises a rotating shaft, and the rotating shaft is connected to the door and the first connecting plate to allow the door to rotate relative to the first connecting plate.

8. The chainsaw bracket according to claim 7, wherein the first connecting plate comprises two shaft connecting portions extending away from the second connecting plate at an upper end and a lower end thereof, respectively, and upper and lower ends of the rotating shaft are pivotably connected to the two shaft connecting portions.

9. The chainsaw bracket according to claim 2, wherein the chainsaw bracket further comprises a hand-tightened screw, wherein a connecting block protrudes from a surface of the second connecting plate facing away from the first connecting plate, and a threaded end of the hand-tightened screw passes through the door and is threadedly and detachably engaged with the connecting block.

10. The chainsaw bracket according to claim 8, wherein a side of the first connecting plate distal from the plate-shaped main body defines a first notch, a side of the second connecting plate distal from the plate-shaped main body defines a second notch;
wherein, the door is at least partially received within the first notch and the second notch, when the second end of the door is connected to the mounting assembly.

11. The chainsaw bracket according to claim 10, wherein a spacing exists between a lower inner wall of the first notch and an upper surface of the shaft connecting portion at the lower end of the first connecting plate; the door is sleeved on the rotating shaft and is configured to slide axially along the rotating shaft, and when the door is rotated to an open position, the door slides downward along the rotating shaft and abuts against the first connecting plate to prevent further rotation of the door.

12. The chainsaw bracket according to claim 1, wherein the protective sheath comprises a first sheath shell having a first receiving space penetrating up and down and a second sheath shell having a second receiving space detachably connected to a lower portion of the first sheath shell; wherein the receiving space is defined by the first sheath shell and the second sheath shell.

13. The chainsaw bracket according to claim 12, wherein a bottom of the second sheath shell is provided with a drainage hole communicated with the second receiving space.

14. The chainsaw bracket according to claim 12, wherein the first sheath shell is provided with an insertion portion, the second sheath shell is provided with an insertion groove; wherein when the second sheath shell is connected to the lower portion of the first sheath shell, the insertion portion is inserted into the insertion groove.

15. The chainsaw bracket according to claim 1, wherein a protective component is provided inside the protective sheath, the protective component being strip-shaped and extending along left and right inner sidewalls of the receiving space.

16. The chainsaw bracket according to claim 2, wherein the mounting assembly further comprises a first clamping plate, a second clamping plate, two bolts and two first nuts;
wherein the first clamping plate is provided with a first through hole and a second through hole, the second clamping plate is provided with a third through hole and a fourth through hole;
the two bolts are configured as follows: one bolt passes through the first through hole and the third through hole, another bolt passes through the second through hole and the fourth through hole;
the two first nuts are respectively connected to the two bolts, and the two first nuts and bolt heads of the two bolts respectively abut against an inner surface of the first clamping plate and an outer surface of the second clamping plate, thereby causing the first clamping plate and the second clamping plate to stably clamped on the vehicle.

17. The chainsaw bracket according to claim 16, wherein a fifth through hole and a sixth through hole are respectively provided at two ends of the plate-shaped main body;
the mounting assembly further comprises two second nuts, wherein one of the two bolts passes through the fifth through hole and another one of the two bolts passes through the sixth through hole, and the two second nuts are respectively threadedly engaged with the two bolts and abut against the outer surface of the plate-shaped main body, thereby connecting the plate-shaped main body to the second clamping plate.

18. The chainsaw bracket according to claim 17, wherein the mounting base further comprises two door-shaped protruding portions connected to an inner side surface of the plate-shaped main body, and the door-shaped protruding portions abut against the outer surface of the second clamping plate.

19. The chainsaw bracket according to claim 18, wherein ends of the two door-shaped protruding portions away from the plate-shaped main body are each provided with an avoidance hole, and the first nut is located within the avoidance hole.
